(19) United States
(12) Patent Application Publication
(10) Pub. No.: US 2026/0348562 A1
(43) Pub. Date: Nov. 5, 2026

(54) HOUSING AND LIGHTING FIXTURE

(71) Applicants: OPPLE LIGHTING CO., LTD., Shanghai (CN); SUZHOU OPPLE LIGHTING CO., LTD., Suzhou City, Jiangsu (CN)

(72) Inventor: Quanbiao WANG, Shanghai (CN)

(73) Assignees: OPPLE LIGHTING CO., LTD., Shanghai (CN); SUZHOU OPPLE LIGHTING CO., LTD., Suzhou City, Jiangsu (CN)

(21) Appl. No.: 19/724,835

(22) Filed: Jun. 29, 2026

Related U.S. Application Data
(63) Continuation of application No. PCT/CN2024/143241, filed on Dec. 27, 2024.

(30) Foreign Application Priority Data
Dec. 31, 2023 (CN) 202323667881.6

(51) Int. Cl. F21V 17/16; F21V 19/00

(52) U.S. Cl. CPC F21V 17/16; F21V 19/0045

(57) ABSTRACT

A housing for a lighting fixture includes a first housing and a second housing that are snap-fitted together to define a mounting cavity. The first housing includes a mounting wall, a connecting wall having first snap portions, and a relief groove formed adjacent to an end portion of the connecting wall. The second housing includes a base, a first extending wall having second snap portions, and a lip extending outward from an outer edge of the first extending wall. The first snap portions and the second snap portions are snap-connected, and the lip is received within the relief groove and wrapped by the end portion to reduce light leakage and improve the connection between the first housing and the second housing.

### CROSS-REFERENCE TO RELATED DISCLOSURES

This disclosure is based upon and claims the priority of PCT patent disclosure No. PCT/CN 2024/143241 filed on Dec. 27, 2024, which claims priority to the Chinese patent disclosure No. 202323667881.6 filed on Dec. 31, 2023, the entire contents of which are hereby incorporated by reference herein for all purposes.

### TECHNICAL FIELD

The present disclosure relates to a housing and a lighting fixture, and pertains to the field of lighting technology.

### BACKGROUND

Some lighting fixtures generally address safety compliance issues by manually attaching anti-electric-shock warning labels bearing a lightning symbol or applying adhesive at snap-fit portions for fixation.

### SUMMARY

The present disclosure provides a housing for a lighting fixture and a lighting fixture incorporating the housing.

Accordingly, the housing may include a first housing and a second housing that are snap-fitted together to define a mounting cavity for accommodating a light source module. The first housing includes a mounting wall, a connecting wall having first snap portions, and a relief groove formed adjacent to an end portion of the connecting wall. The second housing includes a base, a first extending wall having second snap portions, and a lip extending outward from the first extending wall. The first and second snap portions cooperate to securely connect the first housing and the second housing, while the lip is received within the relief groove and wrapped by the end portion to reduce light leakage and improve the sealing and structural stability of the housing. In some embodiments, the housing further includes mating portions for pre-positioning the first and second housings, stress relief grooves for facilitating snap engagement, and a supporting portion configured to support and position an optical module.

It is to be understood that both the foregoing general description and the following detailed description are exemplary and explanatory only and are not restrictive of the present disclosure.

### BRIEF DESCRIPTION OF DRAWINGS

FIG. 1 is a schematic structural view of a lighting fixture according to a first example of the present disclosure.

FIG. 2 is an exploded view of the lighting fixture of FIG. 1.

FIG. 3 is a schematic cross-sectional view of the lighting fixture of FIG. 1.

FIG. 4 is a schematic cross-sectional view of a part of the structure of the lighting fixture of FIG. 1.

FIG. 5 is a schematic structural view of the first housing in FIG. 1.

FIG. 6 is a schematic structural view of the second housing in FIG. 1.

FIG. 7 is a schematic structural view of the second housing of FIG. 6 from another angle.

FIG. 8 is a schematic structural view of the insulating casing in FIG. 2.

FIG. 9 is an exploded view of the lens assembly in FIG. 2.

FIG. 10 is a schematic structural view of a lighting fixture according to a second example of the present disclosure.

FIG. 11 is an exploded view of the lighting fixture of FIG. 10.

FIG. 12 is a schematic cross-sectional view of the lighting fixture of FIG. 10.

FIG. 13 is a schematic structural view of the external light source assembly in FIG. 11.

FIG. 14 is a schematic structural view of the insulating member in FIG. 11.

FIG. 15 is a schematic structural view of the micro-prism reflector in FIG. 11.

### DETAILED DESCRIPTION

In order to make the objectives, technical solutions, and advantages of the present disclosure clearer, the present disclosure is described in detail below with reference to the accompanying drawings and examples.

It should be noted that, in order to avoid obscuring the present disclosure with unnecessary details, the drawings only show structures and/or processing steps that are closely related to the solution of the present disclosure, while other details that are not closely related to the present disclosure are omitted.

In addition, it should also be noted that the terms “comprise,” “include,” or any other variations thereof are intended to cover non-exclusive inclusion, such that a process, method, article, or device that includes a series of elements includes not only those elements, but also other elements not expressly listed, or also includes elements inherent to such process, method, article, or device.

Some lighting fixtures generally address safety compliance issues by manually attaching anti-electric-shock warning labels bearing a lightning symbol or applying adhesive at snap-fit portions for fixation. Such operations are cumbersome and inconvenient.

In view of this, it is indeed necessary to provide a housing and a lighting fixture to address the aforementioned problems.

Description of Reference Numerals may include:
lighting fixture 100;
housing 10, first housing 11, mounting wall 111, first fool-proof portion 113, wire groove 114, first positioning member 115, first mounting hole 116, connecting wall 112, first snap portion 1121, relief groove 1122, first mating portion 1123, second housing 12, base 121, supporting portion 122, second extending wall 1221, supporting wall 1222, first positioning snap-engaging portion 1223, first extending wall 123, second snap portion 1231, snap protrusion 1232, inclined guiding surface 1233, snap-engaging surface 1234, inclined end face 1235, stress relief groove 1236, inclined surface 1237, second mating portion 1238, lip 124, mounting shaft 125, mounting cavity 13, accommodating space 131, third housing 14, shaft groove 141, face ring 15, spring clip 16, light outlet 17;
light source module 20, built-in light source module 21, built-in light source assembly 211, insulating casing 212, top wall 2121, first wire fixing cavity 2122, second fool-proof portion 2123, peripheral wall 2124, first power cord 213, external light source module 22, external light source assembly 221, light source holder 222, mounting portion 2221, outer edge portion 2222, second wire fixing cavity 2223, third fool-proof portion 2224, second mounting hole 2225, second power cord 223, insulating member 224, escape hole 2241, relief recess 2242, relief notch 2243, second positioning member 225;
optical module 30, first end 31, second end 32, second positioning snap-engaging portion 321, side wall 33, lens assembly 34, lens 341, lens holder 342, micro-prism reflector 35.

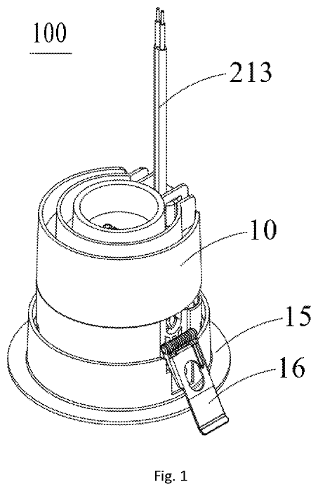

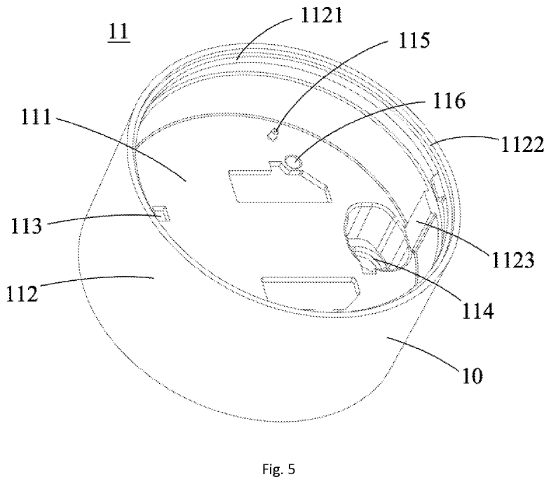

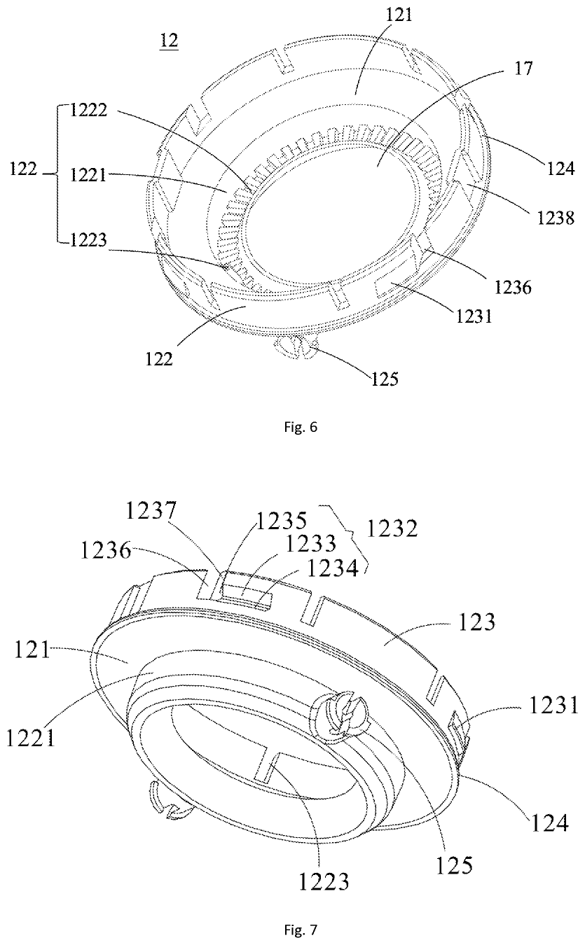

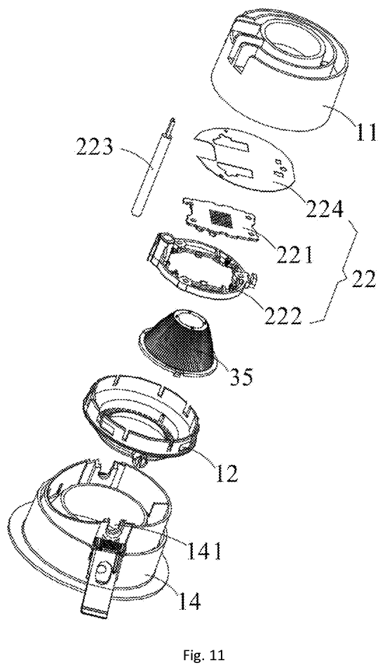

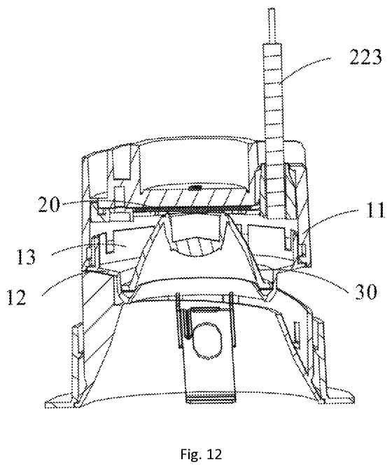

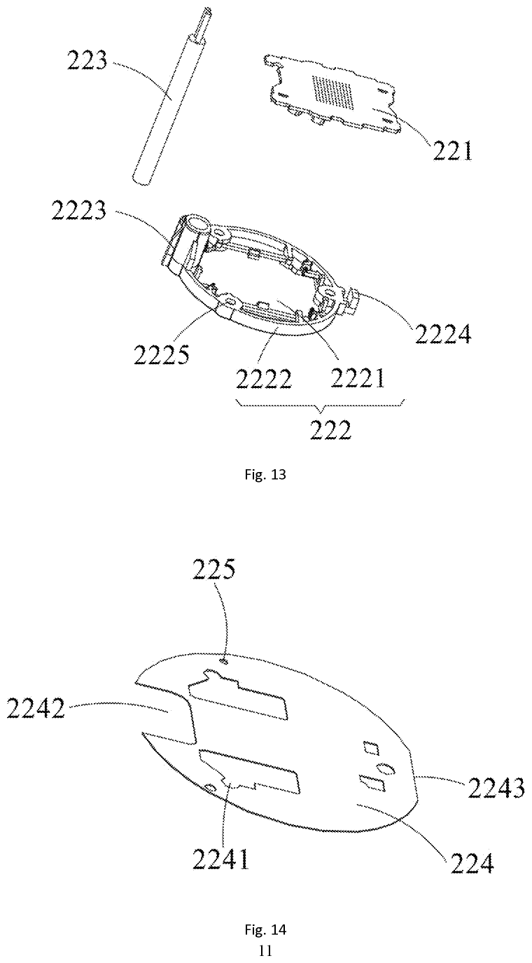

Referring to FIGS. 1 to 14, the present disclosure provides a lighting fixture 100. The lighting fixture 100 includes a housing 10, a light source module 20, and an optical module 30. The housing 10 includes a first housing 11 and a second housing 12, with a mounting cavity 13 defined between the first housing 11 and the second housing 12. The light source module 20 is disposed in the mounting cavity 13 and abuts against the first housing 11. The optical module 30 is disposed in the mounting cavity 13 and located between the light source module 20 and the second housing 12.

Optionally, the light source module 20 may be either a built-in light source module 21 or an external light source module 22. The first housing 11 is provided with a first mounting structure and a second mounting structure. The built-in light source module 21 is adapted to be mounted to the first mounting structure, and the external light source module 22 is adapted to be mounted to the second mounting structure. By providing the first mounting structure and the second mounting structure on the first housing 11, where the first mounting structure is adapted for mounting the built-in light source module 21 and the second mounting structure is adapted for mounting the external light source module 22, a single housing 10 can be matched with different light source modules 20. This solves the problem of the conventional lighting fixture being single-purpose, and allows different mounting structures to be matched according to different light source modules 20, thereby enabling one lighting fixture for multiple uses and meeting various customization requirements.

Further, the first mounting structure and the second mounting structure have common structural components. That is, some structural components of the first mounting structure are the same as those of the second mounting structure. By arranging common structural components for snap-mounting different light source modules 20, the structural design on the first housing 11 can be reduced, making the structure of the first housing 11 simple, reducing processes, and saving costs, while still achieving one lighting fixture for multiple uses.

Optionally, the second mounting structure includes the first mounting structure and further has structural components different from those of the first mounting structure. That is, the second mounting structure has the same structural components as the first mounting structure, as well as some unique structural components for connecting with the external light source module 22. With this arrangement, different light source modules 20 can be adapted while saving costs, thereby improving the applicability of the housing 10 of the lighting fixture 100.

Optionally, the optical module 30 may also be any one of a micro-prism reflector 35 and a lens assembly 34, or may be other forms of structures, without any limitation. The second housing 12 is also provided with a supporting portion 122 adapted to the optical module 30. By providing the supporting portion 122 on the second housing 12 to match multiple optical modules 30, different optical elements can be selected according to different lighting requirements, thereby achieving one lighting fixture for multiple uses.

To clearly describe the structure of the lighting fixture 100 of the present disclosure, the following description illustrates the present disclosure with reference to some examples, but those skilled in the art will appreciate that the present disclosure is not limited thereto.

Referring to FIGS. 1 to 9, a first example of the lighting fixture 100 of the present disclosure is shown. In the present example, the lighting fixture 100 includes a housing 10, a light source module 20, and an optical module 30. The light source module 20 is a built-in light source module 21, and the optical module 30 is a lens assembly 34.

The housing 10 includes a first housing 11, a second housing 12, and a third housing 14. The second housing 12 is disposed between the first housing 11 and the third housing 14, and is connected to the first housing 11 and the third housing 14, respectively. The first housing 11 and the second housing 12 are snap-fitted, and a mounting cavity 13 for accommodating the light source module 20 and the optical module 30 is defined between the first housing 11 and the second housing 12. The third housing 14 is configured to be connected to a mounting base, and the third housing 14 is rotatably connected to the second housing 12. By rotating the second housing 12, the first housing 11 is driven to rotate synchronously, thereby changing the light-emitting direction of the lighting fixture 100.

The first housing 11 includes a mounting wall 111 and a connecting wall 112 extending from the mounting wall 111 toward the second housing 12. The mounting wall 111 is configured for mounting connection with the light source module 20, and the connecting wall 112 is configured for snap-fitting with the second housing 12.

The first mounting structure includes a first fool-proof portion 113 and a wire groove 114 provided on the mounting wall 111. The first fool-proof portion 113 is configured for positioning snap-engagement with an insulating casing 212 in the built-in light source module 21, and the wire groove 114 is configured for snap-engagement with a first power cord 213 in the built-in light source module 21 and for allowing the first power cord 213 to pass therethrough to connect to an external mains power supply.

In the present example, the first fool-proof portion 113 is a locking groove recessed from the mounting wall 111 in a direction away from the mounting cavity 13. Of course, in other examples, the first fool-proof portion 113 may also be a protrusion extending from the mounting wall 111 into the mounting cavity 13, and is not limited thereto.

The wire groove 114 is provided at an opposite end of the locking groove and is recessed from the mounting wall 111 in a direction away from the mounting cavity 13. The wire groove 114 includes a first opening facing the mounting cavity 13 and a second opening away from the mounting cavity 13. The area of the first opening is larger than the area of the second opening. Such arrangement facilitates the first wire fixing cavity 2122, which is snap-engaged with the first power cord 213, to enter the wire groove 114 through the first opening, while is snap-limited by the second opening.

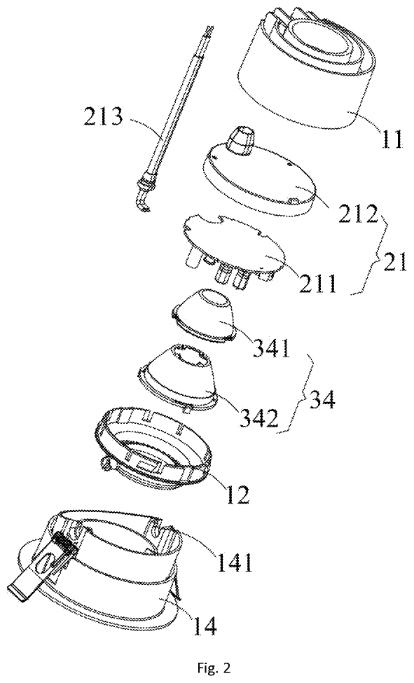

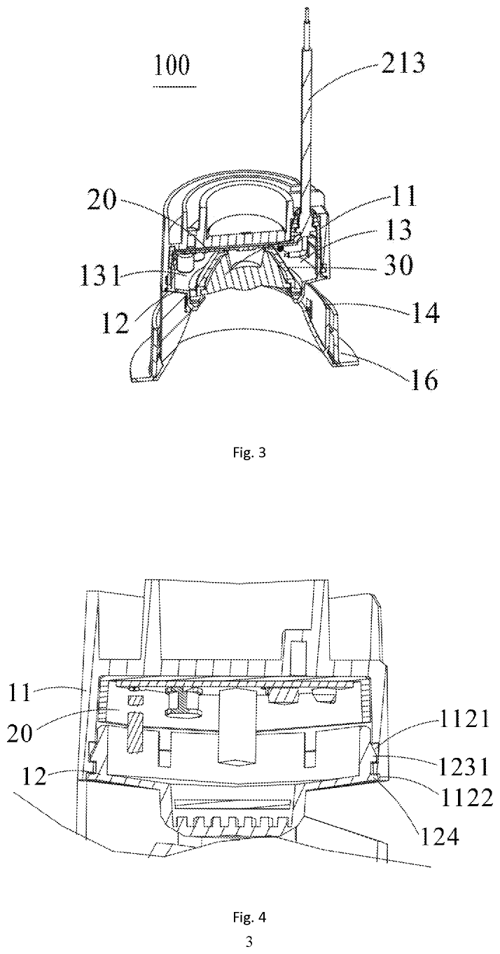

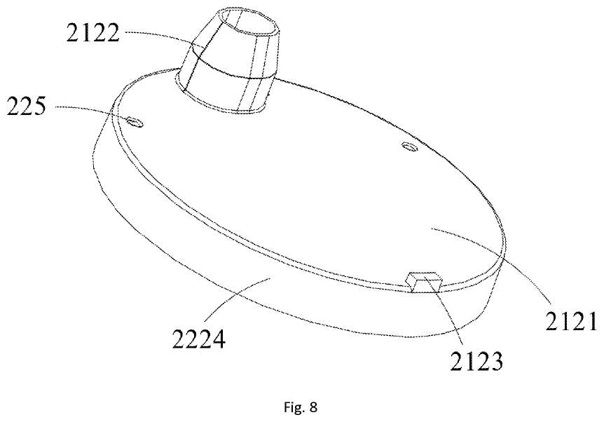

Referring to FIG. 8 in conjunction with FIGS. 2 and 3, the built-in light source module 21 includes a built-in light source assembly 211, an insulating casing 212, and a first power cord 213. The insulating casing 212 is disposed between the built-in light source assembly 211 and the first housing 11. The built-in light source assembly 211 and the first power cord 213 are electrically connected, and the connected built-in light source assembly 211 is located on a side of the insulating casing 212 facing away from the mounting wall 111.

In the present example, the built-in light source assembly 211 is a DOB (Driver-on-Board) optoelectronic integrated light source component, which includes a first power supply board, a light-emitting assembly disposed on the first power supply board, and non-light-emitting components surrounding the light-emitting assembly. The non-light-emitting components are electrical components and the like. The first power cord 213 is electrically connected to the first power supply board.

The insulating casing 212 includes a top wall 2121 facing the mounting wall 111 and a peripheral wall 2124 extending from the top wall 2121 in a direction away from the mounting wall 111. The top wall 2121 and the peripheral wall 2124 together define a receiving groove for accommodating the built-in light source assembly 211. Positioning posts for positioning connection with the built-in light source assembly 211 are provided in the receiving groove.

A side of the top wall 2121 facing away from the receiving groove (i.e., a side facing away from the built-in light source assembly 211) is provided with a second fool-proof portion 2123 for snap-engagement with the first fool-proof portion 113, and a first wire fixing cavity 2122 for snap-engagement with the wire groove 114.

In the present example, the second fool-proof portion 2123 is a protrusion extending from the top wall 2121 in a direction away from the receiving groove, and the protrusion engages with the locking groove to achieve fool-proofing between the built-in light source module 21 and the first housing 11. Of course, in other examples, the second fool-proof portion 2123 may also be a locking groove recessed from the top wall 2121 toward the receiving groove, and is not limited thereto.

The first wire fixing cavity 2122 allows the first power cord 213 to pass therethrough and be snap-engaged, and is positioned corresponding to the wire groove 114 so as to be snap-fitted into the wire groove 114. A snap protrusion for snap-engagement with the first power cord 213 is provided in the first wire fixing cavity 2122, and the first power cord 213 is fixedly snap-engaged in the first wire fixing cavity 2122 by the snap protrusion. The first power cord 213 is snap-engaged through the first wire fixing cavity 2122 and the wire groove 114, and is configured to pass sequentially through the first wire fixing cavity 2122 and the wire groove 114 to connect to the mains power supply.

Optionally, in order to enhance the mounting and positioning between the built-in light source module 21 and the first housing 11, the first housing 11 is further provided with a first positioning member 115, and the insulating casing 212 of the built-in light source module 21 is correspondingly provided with a second positioning member 225.

Continuing to refer to FIGS. 3 and 7, the mounting wall 111 is further provided with a first positioning member 115. The first positioning member 115 is a positioning post extending from the mounting wall 111 into the mounting cavity 13. The top wall 2121 of the insulating casing 212 is provided with a second positioning member 225. The second positioning member 225 is a positioning hole, and the positioning post is snap-fitted into the positioning hole to achieve positioning connection between the mounting wall 111 and the insulating casing 212.

Optionally, a plurality of positioning posts may be provided, for example two, and the two positioning posts are respectively disposed on two sides of the mounting wall 111 and at positions different from those of the first fool-proof portion 113 and the wire groove 114. Similarly, a plurality of positioning holes are also provided, and the positions of the plurality of positioning holes correspond to the positions of the positioning posts.

After the built-in light source module 21 is connected to the mounting wall 111 of the first housing 11 via the first mounting structure, one end of the optical module 30 abuts against the built-in light source module 21, and the other end is snap-engaged with the second housing 12.

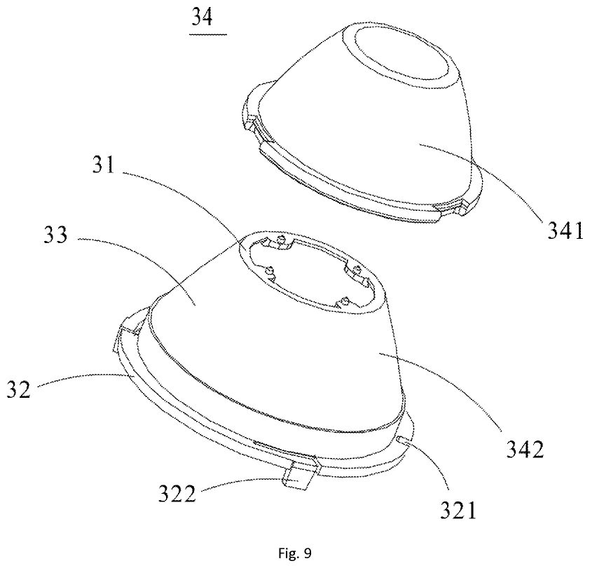

Referring to FIG. 9 in conjunction with FIGS. 2 and 3, in the present example, the optical module 30 is a lens assembly 34 (e.g., a TR lens 341). The lens assembly 34 includes a lens 341 and a lens holder 342. The lens holder 342 is internally provided with a mounting position for mounting the lens 341. A first end 31 and a second end 32 of the lens holder 342 respectively abut against the light source module 20 and the second housing 12.

The lens holder 342 includes the first end 31, the second end 32, and a side wall 33 connecting the first end 31 and the second end 32. The side wall 33 together with the first end 31 and the second end 32 defines the mounting position for mounting the lens 341. The diameter of the first end 31 is smaller than the diameter of the second end 32. The small-diameter end of the lens 341 is connected to the first end 31, and the large-diameter end of the lens 341 is connected to the second end 32.

The first end 31 is provided with abutting portions extending toward the built-in light source assembly 211. Four abutting portions abut against the outer side of the light-emitting assembly of the built-in light source assembly 211, so that the first end 31 covers the outer side of the light-emitting assembly, allowing light emitted by the light-emitting assembly to be emitted after passing through the optical effect of the lens 341, thereby adjusting the lighting state of the lighting fixture 100.

In addition, the first end 31 is the end with a smaller diameter, and an accommodating space 131 for accommodating the non-light-emitting components outside the light-emitting assembly is provided between the side wall 33 connected to the first end 31 and the connecting wall 112 of the first housing 11. That is, the non-light-emitting components (electrical components) on the first power supply board of the DOB optoelectronic integrated light source component can be installed in the accommodating space 131, so as to make reasonable use of the space of the housing 10 and reduce the volume of the lighting fixture 100.

An edge portion is formed by extending outward from the end of the second end 32, and the edge portion is configured to abut against and be mounted in the supporting portion 122 of the second housing 12.

For rapid positioning and snap-engagement, the supporting portion 122 of the second housing 12 is provided with a first positioning snap-engaging portion 1223, and correspondingly, the edge portion of the second end 32 is provided with a second positioning snap-engaging portion 321. The first positioning snap-engaging portion 1223 and the second positioning snap-engaging portion 321 are positioned and connected. Optionally, the first positioning snap-engaging portion 1223 is a positioning rib provided on the second extending wall 1221 of the supporting portion 122, and the second positioning snap-engaging portion 321 is a positioning groove formed by recessing the edge portion inward.

Further, an engaging block is provided on the edge portion extending toward the second housing 12, and correspondingly, an engaging groove is provided on the supporting wall 1222 of the supporting portion 122, and the engaging block is snap-fitted into the engaging groove.

Continuing to refer to FIGS. 2 to 7, the first housing 11 and the second housing 12 are positioned and snap-fitted, and after snap-fitting, can achieve anti-disassembly and anti-light-leakage effects.

Specifically, the first housing 11 includes a mounting wall 111 and a connecting wall 112 extending from the mounting wall 111 toward the second housing 12. The connecting wall 112 is provided with at least two first snap portions 1121, which are configured for snap connection with the second snap portions 1231 on the second housing 12, so as to achieve an anti-disassembly effect.

Optionally, in the present example, the first snap portion 1121 is a snap groove provided on the connecting wall 112 near the second housing 12. The snap groove is an annular groove. Of course, in other examples, the first snap portion 1121 may also be a snap protrusion 1232, and is not limited thereto.

The connecting wall 112 includes an end portion adjacent to the second housing 12, and a relief groove 1122 is formed on the inner side of the end portion. The relief groove 1122 is configured to receive the lip 124 of the second housing 12, thereby completely wrapping the second housing 12 within the first housing 11, achieving an anti-light-leakage effect.

Further, since the relief groove 1122 is also annular and is disposed below the snap groove, a snap step is formed between the relief groove 1122 and the snap groove, and the snap step abuts against the upper surface of the lip 124 of the second housing 12. Since the snap step is located below the snap groove, when the snap step is subjected to an external force, the force application point is not located at either the first snap portions 1121 or the second snap portions 1231, thereby preventing the first housing 11 from detaching.

The second housing 12 includes a base 121 and a first extending wall 123 extending from the base 121 toward the first housing 11. The inner side of the first extending wall 123 has a light outlet 17, and the first extending wall 123 is provided with at least two second snap portions 1231. The outer edge of the first extending wall 123 is provided with a lip 124 extending outward. The first snap portions 1121 and the second snap portions 1231 are snap-connected, and the lip 124 is received in the relief groove 1122 and wrapped by the end portion. Through the snap connection of the first snap portions 1121 and the second snap portions 1231, the anti-disassembly effect of the housing 10 is achieved. Meanwhile, after the first housing 11 and the second housing 12 are snap-fitted, the lip 124 of the second housing 12 is received in the relief groove 1122 of the first housing 11 and wrapped by the end portion of the first housing 11, thereby achieving an anti-light-leakage effect.

In the present example, the second snap portion 1231 is a snap protrusion 1232 provided on the first extending wall 123. Of course, in other examples, the second snap portion 1231 may also be a snap groove.

Further, the snap protrusion 1232 is an annular inclined snap protrusion 1232. The snap protrusion 1232 includes a snap-engaging surface 1234 facing the second housing 12, an inclined guiding surface 1233 facing the lip 124, and two inclined end faces 1235 connecting the snap-engaging surface 1234 and the inclined guiding surface 1233. Moreover, the edge of the snap-engaging surface 1234 connecting the two inclined end faces 1235 is an arcuate edge. For example, the snap-engaging surface 1234 of the snap protrusion 1232 is an arcuate surface, so as to match the arcuate surface of the snap groove. By providing the inclined snap protrusion 1232, the contact area between the snap protrusion 1232 and the snap groove can be increased, thereby achieving the anti-disassembly effect. By providing the inclined guiding surface 1233, the snap connection between the second housing 12 and the first housing 11 is guided.

Optionally, the first extending wall 123 is provided with a plurality of snap protrusions 1232, and the plurality of snap protrusions 1232 are arranged circumferentially along the first extending wall 123. Two adjacent snap protrusions 1232 are arranged in mirror symmetry. Such arrangement can improve the stability of the snap protrusions 1232 with the snap groove.

The connecting wall 112 is further provided with a stress relief groove 1236 having an inclination direction consistent with that of the snap protrusion 1232. The stress relief groove 1236 is disposed adjacent to the snap protrusion 1232, and the stress relief groove 1236 has a pair of inclined surfaces 1237. The inclined surface 1237 adjacent to the snap protrusion 1232 is connected to the inclined end face 1235 and lies on the same plane. By providing the stress relief groove 1236, the deformation distance of the first extending wall 123 can be reduced.

Further, in order to quickly snap-fit the first housing 11 and the second housing 12, a first mating portion 1123 for mating with the second housing 12 is provided on the inner side of the connecting wall 112. The side of the first extending wall 123 facing the lip 124 is correspondingly provided with a second mating portion 1238 for positioning snap-engagement with the first mating portion 1123.

Optionally, one of the first mating portion 1123 and the second mating portion 1238 is a mating protrusion, and the other is a mating groove.

In the present example, the first mating portion 1123 is a mating protrusion protruding from the inner side of the connecting wall 112 into the mounting cavity 13. The mating protrusion is interrupted at the position of the snap groove to provide clearance for the snap groove. Moreover, a guiding surface 1233 is provided on the side of the mating protrusion facing the second housing 12 to facilitate installation.

The second mating portion 1238 is a mating groove recessed from the outer side to the inner side of the first extending wall 123, and the mating groove is configured for snap-positioning with the mating protrusion.

Further, the mating protrusion is disposed below the wire groove 114, and therefore, the insulating casing 212 is provided with a relief recess at a position corresponding to the mating protrusion, and the relief recess is located below the first wire fixing cavity.

Further, the second housing 12 is further provided with a supporting portion 122 for supporting the optical module. The supporting portion 122 is formed by recessing from the base 121 in a direction away from the first housing 11, and the supporting portion 122 surrounds the light outlet 17.

The supporting portion 122 includes a second extending wall 1221 extending away from the first housing 11, and a supporting wall 1222 extending from the second extending wall 1221 into the light outlet 17. That is, the supporting wall 1222 is located on the inner side of the second extending wall 1221 and is configured to abut against the optical module 30. The supporting wall 1222 is provided with a plurality of reinforcing ribs, and gaps are formed between adjacent reinforcing ribs, thereby forming engaging grooves for engaging with engaging blocks on the second housing 12.

The second extending wall 1221 is provided with a first positioning snap-engaging portion 1223 for positioning snap-engagement with the optical module 30. Optionally, the first positioning snap-engaging portion 1223 is a positioning rib provided on the second extending wall 1221 of the supporting portion 122, and the positioning rib is positioned and snap-engaged with a positioning groove on the optical module 30.

A mounting shaft 125 protruding outward is provided on the outer side of the supporting portion 122, and the third housing 14 is correspondingly provided with a shaft groove 141. The mounting shaft 125 is positioned and snap-fitted into the shaft groove 141, so as to achieve snap-fixing between the second housing 12 and the third housing 14. Meanwhile, since the mounting shaft 125 can rotate in the shaft groove 141, the second housing 12 can rotate relative to the third housing 14, thereby adjusting the light-emitting direction of the lighting fixture 100.

Further, the inner side of the third housing 14 is configured as a horn-shaped light-emitting channel, with the small opening disposed near the second housing 12 and the large opening disposed near the face ring 15, so as to increase the light-emitting area.

A notch portion is further provided between the third housing 14 and the second housing 12, and the notch portion can assist in heat dissipation of the lighting fixture 100.

Further, a face ring 15 is provided on the side of the third housing 14 away from the second housing 12, and the face ring 15 is provided with a spring clip 16, through which the lighting fixture 100 is connected to a mounting base.

Further, in order to improve heat dissipation, the side of the first housing 11 facing away from the mounting cavity 13 is provided with a plurality of heat dissipation fins. The housing 10 has a plurality of first housings 11 with the same internal structure but different heights of the heat dissipation fins, so that different first housings 11 can be replaced according to the power of the light source module 20.

### Example 2

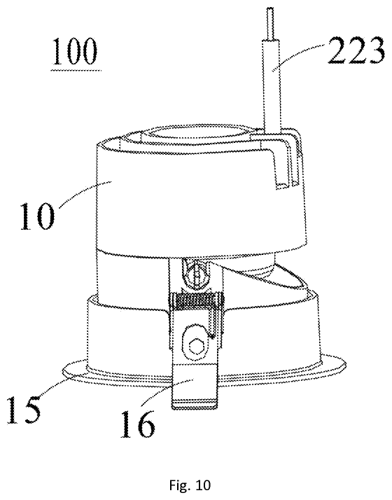

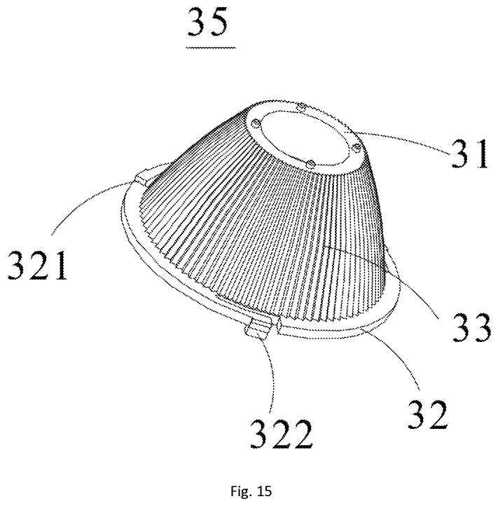

Referring to FIGS. 10 to 15, a lighting fixture 100 according to a second example of the present disclosure is shown. In the present example, the lighting fixture 100 includes a housing 10, a light source module 20, and an optical module 30. The structure of the housing 10 is the same as that of the housing 10 in the first example. The difference lies in that, in the present example, the light source module 20 is an external light source module 22, which is mounted in the mounting cavity 13 via the second mounting structure on the first housing 11, and the optical module 30 is a micro-prism reflector. To avoid repetition, only the differences are described in detail in the present example, and the same portions are not repeated.

The external light source module 22 includes an external light source assembly 221, a light source holder 222, and a second power cord 223. The external light source assembly 221 is electrically connected to the second power cord 223 and is detachably connected to the light source holder 222.

The light source holder 222 includes a mounting portion 2221 for mounting the external light source assembly 221, and an outer edge portion 2222 provided at the outer periphery of the mounting portion 2221. The outer edge portion 2222 is provided with a second wire fixing cavity 2223 for allowing the second power cord 223 to pass therethrough.

The second mounting structure includes a first fool-proof portion 113, a wire groove 114, and a first mounting hole 116. The first fool-proof portion 113 and the wire groove 114 are the same structures as those on the first mounting structure, while the first mounting hole 116 is a structure specific to the second mounting structure, configured for fixed connection with the light source holder 222.

The outer edge portion 2222 of the light source holder 222 is correspondingly provided with a third fool-proof portion 2224, a second wire fixing cavity 2223, and a second mounting hole 2225. The third fool-proof portion 2224 is snap-engaged with the first fool-proof portion 113. The second wire fixing cavity 2223 is positioned corresponding to the wire groove 114 and can be snap-fitted into the wire groove 114. The second power cord 223 is configured to pass sequentially through the second wire fixing cavity 2223 and the wire groove 114. A fastener passes through the first mounting hole 116 and the second mounting hole 2225 to fixedly connect the light source holder 222 to the first housing 11.

Since the first fool-proof portion 113 is a structure common to both the first mounting structure and the second mounting structure, the correspondingly connected second fool-proof portion 2123 and third fool-proof portion 2224 have the same structure.

In the present example, the first fool-proof portion 113 is a locking groove provided on the mounting wall 111, and the third fool-proof portion 2224 is a protrusion provided on the light source holder 222. Of course, in other examples, the first fool-proof portion 113 may be a protrusion, and the third fool-proof portion 2224 may be a locking groove.

In particular, the fastener is configured to pass through the first mounting hole 116 and the second mounting hole 2225 to fix the light source holder 222 and the external light source assembly 221 to the mounting wall. The fastener may be a ST.* self-tapping screw and M* screws, where one ST.* screw is provided and three M* screws are provided. The ST. * screw is a pull-resistant screw to enhance the fixing effect with the light source holder 222.

In the present example, the external light source assembly 221 is an external light source assembly 221 that is non-insulated. Therefore, an insulating member 224 is further interposed between the external light source assembly 221 that is non-insulated and the mounting wall 111. Preferably, the insulating member 224 is an insulating thermally conductive silicone cloth interposed between the external light source assembly 221 and the mounting wall 111.

The insulating thermally conductive silicone cloth is disposed between the external light source assembly 221 and the mounting wall 111 of the first housing 11. The second mounting structure further includes a first positioning member 115 provided on the mounting wall 111 of the first housing 11, and the insulating thermally conductive silicone cloth is correspondingly provided with a second positioning member 225 for positioning connection with the first positioning member 115.

Optionally, the first positioning member 115 is a positioning post extending from the mounting wall 111 into the mounting cavity 13. The second positioning member 225 is a positioning hole provided on the insulating thermally conductive silicone cloth, and the positioning post is snap-fitted into the positioning hole to achieve positioning connection between the mounting wall 111 and the insulating thermally conductive silicone cloth.

Optionally, a plurality of positioning posts may be provided, for example two, and the two positioning posts are respectively disposed on two sides of the mounting wall 111 and at positions different from those of the first fool-proof portion 113 and the wire groove 114. Similarly, a plurality of positioning holes are also provided, and the positions of the plurality of positioning holes correspond to the positions of the positioning posts.

Since the insulating member 224 is interposed between the external light source assembly 221 (especially the light source holder 222) and the mounting wall 111, the light source holder 222 is provided with a mounting structure for fixed connection with the mounting wall 111. The mounting structure includes the third fool-proof portion 2224, the second wire fixing cavity 2223, and the second mounting hole 2225. The third fool-proof portion 2224 is configured to be snap-engaged with the first fool-proof portion 113 of the mounting wall 111. The second wire fixing cavity 2223 is configured to be snap-engaged with the wire groove 114 on the mounting wall 111. The second mounting hole 2225 is configured to be engaged with the first mounting hole 116 on the mounting wall 111.

The insulating member 224 is provided with escape structures at positions corresponding to the mounting structure. The insulating member 224 is further provided with an escape hole 2241 for avoiding the first mounting hole 116, and a relief recess 2242 for avoiding the wire groove 114.

The light source holder 222 is provided with a mounting structure for fixed connection with the mounting wall 111, and the insulating member 224 is provided with escape structures at positions corresponding to the mounting structure. The escape structures include an escape hole 2241, a relief recess 2242, and a relief notch 2243. The escape hole 2241 corresponds to the first mounting hole 116, the relief recess 2242 corresponds to the second wire fixing cavity 2223, and the relief notch 2243 corresponds to the third fool-proof portion 2224.

Optionally, in the present example, the optical module 30 is a micro-prism reflector 35.

The micro-prism reflector 35 includes a first end 31, a second end 32, and a side wall 33 connecting the first end 31 and the second end 32. The diameter of the first end 31 is smaller than the diameter of the second end 32. The side wall 33 is provided with a plurality of micro-prism structures.

The first end 31 is provided with abutting portions extending toward the external light source assembly 221. Four abutting portions abut against the outer side of the light-emitting assembly of the external light source assembly 221, so that the first end 31 covers the outer side of the light-emitting assembly, allowing light emitted by the light-emitting assembly to be emitted after passing through the optical effect of the micro-prism reflector 35, thereby adjusting the lighting state of the lighting fixture 100.

An edge portion is formed by extending outward from the end of the second end 32, and the edge portion is configured to abut against and be mounted in the supporting portion 122 of the second housing 12. An engaging block is provided on the edge portion extending toward the second housing 12, and correspondingly, an engaging groove is provided on the supporting wall 1222 of the supporting portion 122, and the engaging block is snap-fitted into the engaging groove.

For rapid positioning and snap-engagement, the supporting portion 122 of the second housing 12 is provided with a first positioning snap-engaging portion 1223, and correspondingly, the edge portion is provided with a second positioning snap-engaging portion 321. The first positioning snap-engaging portion 1223 and the second positioning snap-engaging portion 321 are positioned and connected. Optionally, the first positioning snap-engaging portion 1223 is a positioning rib provided on the second extending wall 1221 of the supporting portion 122, and the second positioning snap-engaging portion 321 is a positioning groove formed by recessing the edge portion inward.

### Example 3

A lighting fixture 100 according to a third example of the present disclosure includes a housing 10, a light source module 20, and an optical module 30. The basic structure of the housing 10 is the same as that of the housing 10 in the second example. The difference lies in that, in the present example, the light source module 20 is an external light source module 22 that is insulated, and the optical module 30 is a lens assembly 34. The lens assembly 34 has the same structure as that in the first example. To avoid repetition, only the differences are described in detail in the present example, and the same portions are not repeated.

In the present example, since the light source module 20 is an external light source module 22 that is insulated, the external light source module 22 that is insulated is directly mounted on the mounting wall 111 via the second mounting structure on the first housing 11.

The external light source module 22 that is insulated includes a light source holder 222 and an external light source assembly 221 that is insulated. The structures of the light source holder 222 and the external light source assembly 221 that is insulated are the same as those in Example 2, and are not repeated herein.

In the present example, the mounting wall 111 may not be provided with the first positioning member 115. In other words, the first positioning member 115 is located in a gap of the external light source assembly 221 that is insulated and does not affect the installation of the external light source assembly 221, i.e., it plays no role in the installation of the external light source assembly 221.

The external light source assembly 221 that is insulated directly abuts against the mounting wall 111. The mounting wall 111 is provided with the first fool-proof portion 113, and the external light source module 22 that is insulated is correspondingly provided with the third fool-proof portion 2224. The third fool-proof portion 2224 is positioned and snap-engaged with the first fool-proof portion 113. The structures of the first fool-proof portion 113 and the third fool-proof portion 2224 are the same as those in the second example, and are not repeated herein.

### Example 4

A lighting fixture 100 according to a fourth example of the present disclosure includes a housing 10, a light source module 20, and an optical module 30. The housing 10 and the light source module 20 are the same as those in the first example. The difference lies in that, in the present example, the optical module 30 is a micro-prism reflector 35. The micro-prism reflector 35 has the same structure as that in the second example. To avoid repetition, details are not repeated herein.

### Example 5

A lighting fixture 100 according to a fifth example of the present disclosure includes a housing 10, a light source module 20, and an optical module 30. The housing 10 and the light source module 20 are the same as those in the second example. The difference lies in that, in the present example, the optical module 30 is a lens assembly 34. The lens assembly 34 has the same structure as that in the first example. To avoid repetition, details are not repeated herein.

An object of the present disclosure is to provide a housing and a lighting fixture that can enhance the mounting structure of the lighting fixture and prevent detachment.

To achieve the above object, the present disclosure provides a housing for a lighting fixture, including: a first housing and a second housing, where the first housing and the second housing are snap-fitted and have a mounting cavity; the first housing includes a mounting wall and a connecting wall extending from the mounting wall toward the second housing, the connecting wall is provided with at least two first snap portions, the connecting wall including an end portion adjacent to the second housing, a relief groove being formed on an inner side of the end portion; the second housing includes a base and a first extending wall extending from the base toward the first housing, the inner side of the first extending wall is provided with a light outlet, the first extending wall is provided with at least two second snap portions, and an outer edge of the first extending wall is provided with a lip extending outward; the first snap portions and the second snap portions are snap-connected, and the lip is received in the relief groove and wrapped by the end portion.

Optionally, one of the first snap portion and the second snap portion is a snap groove, and another is a snap protrusion.

Optionally, the snap protrusion is an annular inclined snap protrusion, and the snap protrusion includes a snap-engaging surface facing the lip, an inclined guiding surface facing the first housing, and two inclined end faces connecting the snap-engaging surface and the inclined guiding surface, and an edge of the snap-engaging surface connecting the two inclined end faces is an arcuate edge.

Optionally, two adjacent snap protrusions are arranged in mirror symmetry.

Optionally, the second snap portion is a snap protrusion, and the first extending wall is further provided with a stress relief groove having an inclination direction consistent with that of the snap protrusion.

Optionally, the stress relief groove is disposed adjacent to the snap protrusion, and the stress relief groove has a pair of inclined surfaces, and the inclined surface adjacent to the snap protrusion is connected to the inclined end face and lies on the same plane.

Optionally, an inner side of the connecting wall is provided with a first mating portion, and a side of the first extending wall facing the lip is correspondingly provided with a second mating portion for positioning snap-engagement with the first mating portion.

Optionally, one of the first mating portion and the second mating portion is a mating protrusion, and another is a mating groove.

Optionally, the base is recessed in a direction away from the first housing to form a supporting portion, the supporting portion surrounds the light outlet and includes a second extending wall extending away from the first housing and a supporting wall extending from the second extending wall into the light outlet, the supporting wall is configured to abut against the optical module, and the second extending wall is provided with a first positioning snap-engaging portion for positioning snap-engagement with the optical module.

To achieve the above object, the present disclosure further provides a lighting fixture, including a light source module, an optical module, and the housing as described above, where the light source module is located in the mounting cavity, abuts against the mounting wall of the first housing, and emits light toward the light outlet of the housing, and the optical module is disposed between the light source module and the second housing and is configured to control light emitted by the light source module.

The beneficial effects of the present disclosure are as follows: the housing of the present disclosure achieves an anti-disassembly effect through the snap connection of the first snap portions and the second snap portions. Meanwhile, after the first housing and the second housing are snap-fitted, the lip of the second housing is received in the relief groove of the first housing and wrapped by the end portion of the first housing, thereby achieving an anti-light-leakage effect.

The present disclosure may include dedicated hardware implementations such as disclosure specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an disclosure-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples are merely for illustrating the technical solutions of the present disclosure and are not intended to limit the present disclosure. Although the present disclosure has been described in detail with reference to the examples, those of ordinary skill in the art should understand that modifications or equivalent substitutions may be made to the technical solutions of the present disclosure without departing from the spirit and scope of the technical solutions of the present disclosure.

1. A housing, applied to a lighting fixture, comprising: a first housing and a second housing,
wherein the first housing and the second housing are snap-fitted and comprise a mounting cavity,
the first housing comprises a mounting wall and a connecting wall extending from the mounting wall toward the second housing, the connecting wall is provided with at least two first snap portions, the connecting wall comprises an end portion adjacent to the second housing, and a relief groove is formed on an inner side of the end portion;
the second housing comprises a base and a first extending wall extending from the base toward the first housing, an inner side of the first extending wall comprises a light outlet, the first extending wall is provided with at least two second snap portions, and an outer edge of the first extending wall is provided with a lip extending outward;
the first snap portions and the second snap portions are snap-connected; and
the lip is received in the relief groove and the lip is wrapped by the end portion.

2. The housing according to claim 1, wherein one of the first snap portion and the second snap portion comprises a snap groove, and the other comprises a snap protrusion.

3. The housing according to claim 2, wherein the snap protrusion is an annular inclined snap protrusion,
the snap protrusion comprises a snap-engaging surface facing the lip, an inclined guiding surface facing the first housing, and two inclined end faces connecting the snap-engaging surface and the inclined guiding surface, and
an edge of the snap-engaging surface connecting the two inclined end faces is an arcuate edge.

4. The housing according to claim 3, wherein two adjacent snap protrusions are arranged in mirror symmetry.

5. The housing according to claim 3, wherein the second snap portion is a snap protrusion, and the first extending wall is further provided with a stress relief groove having an inclination direction consistent with that of the snap protrusion.

6. The housing according to claim 5, wherein the stress relief groove is disposed adjacent to the snap protrusion, and
the stress relief groove comprises a pair of inclined surfaces, and the inclined surface adjacent to the snap protrusion is connected to the inclined end face and lies on the same plane.

7. The housing according to claim 1, wherein an inner side of the connecting wall is provided with a first mating portion, and
a side of the first extending wall facing the lip is correspondingly provided with a second mating portion for positioning snap-engagement with the first mating portion.

8. The housing according to claim 7, wherein one of the first mating portion and the second mating portion is a mating protrusion, and the other is a mating groove.

9. The housing according to claim 1, wherein the base is recessed in a direction away from the first housing to form a supporting portion,
the supporting portion surrounds the light outlet, the supporting portion comprises a second extending wall extending away from the first housing and a supporting wall extending from the second extending wall into the light outlet, and
the supporting wall is configured to abut against an optical module of the lighting fixture, and the second extending wall is provided with a first positioning snap-engaging portion for positioning snap-engagement with the optical module.

10. A lighting fixture, comprising a light source module, an optical module, and a housing,
wherein the light source module is located in the mounting cavity, abuts against the mounting wall of the first housing, and emits light toward the light outlet of the housing, and
the optical module is disposed between the light source module and the second housing and the optical module is configured to control light emitted by the light source module,
wherein the housing is configured to selectively receive different light source modules and different optical modules,
wherein the housing comprises: a first housing and a second housing,
wherein the first housing and the second housing are snap-fitted and comprise a mounting cavity,
the first housing comprises a mounting wall and a connecting wall extending from the mounting wall toward the second housing, the connecting wall is provided with at least two first snap portions, the connecting wall comprises an end portion adjacent to the second housing, and a relief groove is formed on an inner side of the end portion;
wherein the second housing comprises a base and a first extending wall extending from the base toward the first housing, an inner side of the first extending wall comprises a light outlet, the first extending wall is provided with at least two second snap portions, and an outer edge of the first extending wall is provided with a lip extending outward;
wherein the first snap portions and the second snap portions are snap-connected; and
wherein the lip is received in the relief groove and the lip is wrapped by the end portion.

11. The lighting fixture according to claim 10, wherein one of the first snap portion and the second snap portion is a snap groove, and the other is a snap protrusion.

12. The lighting fixture according to claim 11, wherein the snap protrusion is an annular inclined snap protrusion,
the snap protrusion comprises a snap-engaging surface facing the lip, an inclined guiding surface facing the first housing, and two inclined end faces connecting the snap-engaging surface and the inclined guiding surface, and
an edge of the snap-engaging surface connecting the two inclined end faces is an arcuate edge.

13. The lighting fixture according to claim 12, wherein two adjacent snap protrusions are arranged in mirror symmetry.

14. The lighting fixture according to claim 12, wherein the second snap portion is a snap protrusion, and the first extending wall is further provided with a stress relief groove having an inclination direction consistent with that of the snap protrusion.

15. The lighting fixture according to claim 14, wherein the stress relief groove is disposed adjacent to the snap protrusion, and
the stress relief groove comprises a pair of inclined surfaces, and the inclined surface adjacent to the snap protrusion is connected to the inclined end face and lies on the same plane.

16. The lighting fixture according to claim 10, wherein an inner side of the connecting wall is provided with a first mating portion, and
a side of the first extending wall facing the lip is correspondingly provided with a second mating portion for positioning snap-engagement with the first mating portion.

17. The lighting fixture according to claim 16, wherein one of the first mating portion and the second mating portion is a mating protrusion, and the other is a mating groove.

18. The lighting fixture according to claim 10, wherein the base is recessed in a direction away from the first housing to form a supporting portion,
the supporting portion surrounds the light outlet, the supporting portion comprises a second extending wall extending away from the first housing and a supporting wall extending from the second extending wall into the light outlet, and
the supporting wall is configured to abut against an optical module of the lighting fixture, and the second extending wall is provided with a first positioning snap-engaging portion for positioning snap-engagement with the optical module.

19. The housing according to claim 1, wherein the first housing further comprises a first mounting structure configured to mount a built-in light source module and a second mounting structure configured to mount an external light source module.

20. The housing according to claim 19, wherein the first mounting structure and the second mounting structure share one or more common structural components.
